(19) United States
(12) Patent Application Publication
(10) Pub. No.: US 2011/0080268 A1
(43) Pub. Date: Apr. 7, 2011

(54) SALES DATA PROCESSING APPARATUS AND DATA PROCESSING METHOD

(75) Inventor: Toshihiro Kaneko, Shizuoka (JP)

(73) Assignee: TOSHIBA TEC KABUSHIKI KAISHA, Tokyo (JP)

(21) Appl. No.: 12/894,439

(22) Filed: Sep. 30, 2010

(30) Foreign Application Priority Data
Oct. 7, 2009 (JP) 2009-233661

(51) Int. Cl. H04Q 5/22; G06K 7/01; G06K 7/14

(52) U.S. Cl. 340/10.4; 235/375

(57) ABSTRACT

According to one embodiment, a sales data processing apparatus includes: a commodity-information reading section configured to read, from a scanner, commodity information included in a code symbol attached to a commodity; and a tag invalidating section configured to invalidate an RFID tag attached to the commodity, when the commodity-information reading section reads the commodity information.

### CROSS-REFERENCE TO RELATED APPLICATIONS

This application is based upon and claims the benefit of priority from the prior Japanese Patent Application No. 2009-233661, filed on Oct. 7, 2009; the entire contents of which are incorporated herein by reference.

### FIELD

Embodiments described herein relate generally to a sales data processing apparatus and a data processing method.

### BACKGROUND

Among stores such as a supermarket, an increasing number of stores manage commodity sales using a rewritable radio frequency identification (RFID) tag instead of commodity management by a code symbol such as a barcode or a two-dimensional code used in the past. In general, in this commodity sales managing system, processing for invalidating the RFID tag is performed by using a dedicated terminal during checkout processing. Specifically, since the RFID tag is valid before the checkout processing, it is possible to prevent shoplifting by setting an RFID reader in a store doorway and sounding an alarm when an uninvalidated RFID tag is detected.

In recent years, there are an increasing number of stores where self-checkout point of sales (POS) terminals for customers to perform sales registration and checkout processing for purchased commodities by themselves are installed to adopt a sales form in which the customers perform the sales registration and the checkout processing for commodities. In general, in such a self-checkout POS terminal, a customer scans a code symbol attached to a commodity with a scanner to perform sales registration for the commodity. However, since a dedicated terminal for invalidating an RFID tag is not provided in a setting place of the self-checkout POS terminal, the RFID tag cannot be invalidated during the sales registration. Therefore, regardless of the fact that the checkout processing is completed, an RFID reader provided in a store doorway for shoplifting prevention detects an uninvalidated RFID tag and sounds an alarm.

As measures against this problem, it is conceivable to provide the dedicated terminal in the self-checkout POS terminal. However, this complicates the sales registration processing and imposes a burden on a customer. It is also conceivable that, when it is difficult for the customer to understand a procedure for tag invalidation, the customer calls a store clerk and asks the store clerk to assist the customer in processing for invalidation. However, in this case, burdens are imposed on the customer and the store clerk.

### BRIEF DESCRIPTION OF THE DRAWINGS

FIG. 1 is an external perspective view of the configuration of a self-checkout POS terminal according to an embodiment;

FIG. 2 is an external view for explaining antennas;

FIG. 3 is a schematic diagram for explaining the configuration of a hand scanner;

FIG. 4 is a block diagram of a functional configuration of the POS terminal; and

FIG. 5 is a flowchart for explaining a procedure of tag invalidation processing.

### DETAILED DESCRIPTION

According to one embodiment, a sales data processing apparatus includes: a commodity-information reading section configured to receive, from a scanner, a signal obtained by reading a code symbol attached to a commodity; and a tag invalidating section configured to invalidate an RFID tag attached to the commodity, when the commodity-information reading section receives the signal.

According to one embodiment, a data processing method includes: Reading, from a scanner, commodity information included in a code symbol attached to a commodity, by a commodity-information reading section; and invalidating an RFID tag attached to the commodity, when the commodity-information reading section reads the commodity information, by a tag invalidating section.

A sales data processing apparatus according to an embodiment is used as a self-checkout POS terminal set in a store such as a supermarket.

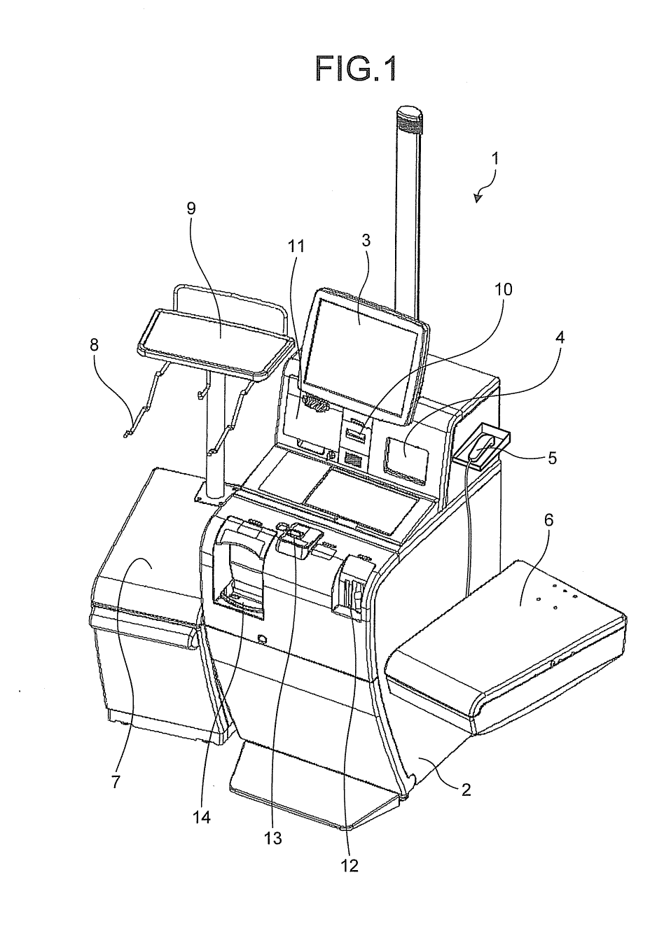

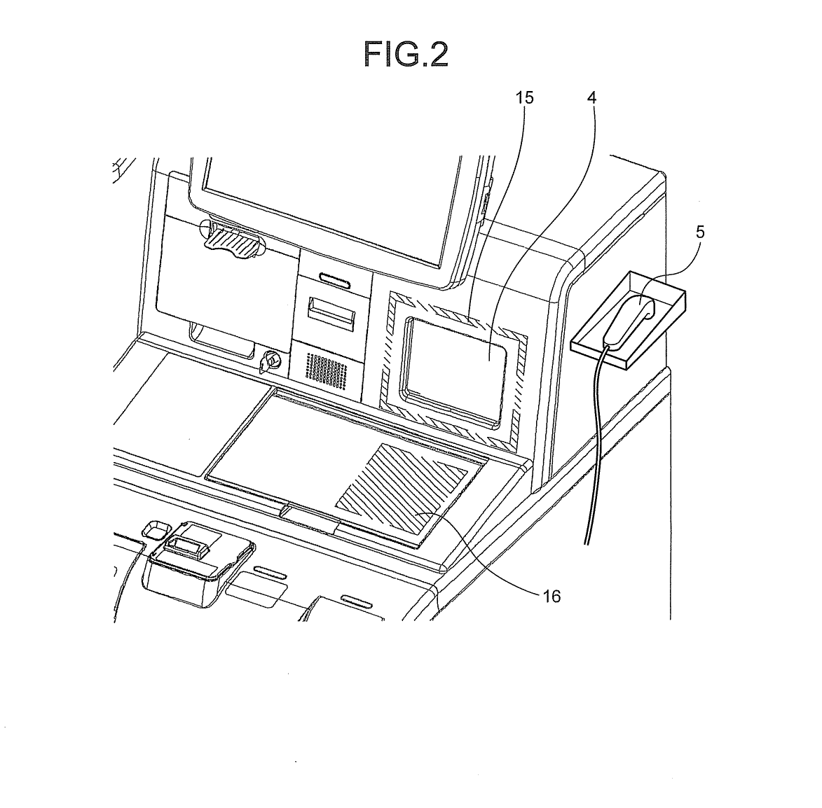

FIG. 1 is an external perspective view of the configuration of a self-checkout POS terminal 1 (hereinafter simply referred to as POS terminal 1) according to the embodiment. FIG. 2 is an external view for explaining an antenna 15. A main body 2 of the POS terminal 1 includes a touch panel display 3 and a scanner 4 (the scanner 4 of the main body 2) and a hand scanner 5 for reading a code symbol such as a barcode or a two-dimensional code attached to a commodity.

The touch panel display 3 is a liquid crystal display device of a touch panel type. The touch panel display 3 displays a guide screen for informing a customer of an operation method for the POS terminal 1 and an input screen for inputting commodity information of a commodity to which a code symbol is not attached. Further, the touch panel display 3 displays a commodity registration screen for displaying commodity information read by the scanner 4 or the hand scanner 5 and a settlement screen for displaying a total amount of commodities, a deposit amount, a change amount, and the like and selecting a payment method.

The scanner 4 is a device configured to optically read a code symbol attached to a commodity when a customer holds the code symbol over a reading window of the scanner 4. The scanner 4 may be the scanner 4 of a laser system configured to irradiate a laser beam on a code symbol and read reflected light of the laser beam with a light receiving element. Alternatively, the scanner 4 may be the scanner 4 of a COD system configured to illuminate a code symbol with a lighting device such as a light emitting diode (LED) and read reflected light of the illumination with a charge coupled device (CCD).

Concerning a large commodity such as a cardboard box or an elongated commodity, it is difficult to hold a code symbol attached to the commodity over the reading window of the scanner 4. Therefore, a customer can read the code symbol using the hand scanner 5.

A commodity placing table 6 for placing unsettled commodities put in a basket is provided on the right side of the main body 2. A commodity placing table 7 for placing settled commodities is provided on the left side of the main body 2. A bag hook 8 for hanging a bag for storing the settled commodities and a temporary placing table 9 for temporarily placing the settled commodities before being stored in the bag are provided in an upper part of the commodity placing table 7. The commodity placing tables 6 and 7 include meters and have a function of confirming that the weight of a commodity is the same before and after settlement.

A card insertion port 10 for inserting a point card or a credit card of a customer during settlement is provided in the main body 2 of the POS terminal 1. A receipt issue port 11 for issuing a receipt is provided in the main body 2. Further, a bill depositing and dispensing port 12 for depositing a bill for settlement and receiving a change bill, a coin depositing port 13 for depositing a coin during settlement, a coin dispensing port 14 for receiving a change coin, and the like are provided in the main body 2.

Antennas 15 and 16 for performing radio data communication with an RFID tag are provided near the scanner 4 of the main body 2. The antennas 15 and 16 transmit data for invalidating an RFID tag to an RFID tag attached to a commodity. The antennas 15 and 16 can also mutually perform communication with the RFID tag attached to the commodity and read commodity information.

As shown in FIG. 2, the antenna 15 is arranged around the reading window of the scanner 4. The antenna 16 is set in a place located below a commodity when a code symbol attached to the commodity is held over the reading window of the scanner 4.

In general, a distance in which communication with an RFID tag is possible is a distance of about 20 centimeters to 30 centimeters from the RFID tag. Therefore, at least two antennas 15 and 16 are provided to emit radio waves to the RFID tag from different directions in this way, whereby the antennas 15 and 16 can be three-dimensionally arranged with respect to the commodity.

Therefore, when an RFID tag is attached in a position where it is difficult to read the RFID tag only with the antenna 15, data communication can be surely performed with the RFID tag by both the antennas 15 and 16 and invalidation of the RFID tag can be surely performed.

On the other hand, concerning a large commodity for which it is difficult to hold a code symbol over the reading window of the scanner 4, the hand scanner 5 is brought close to the code symbol of the commodity to read the code symbol. The hand scanner 5 includes an antenna 17 for performing radio data communication with an RFID tag and can invalidate the RFID tag.

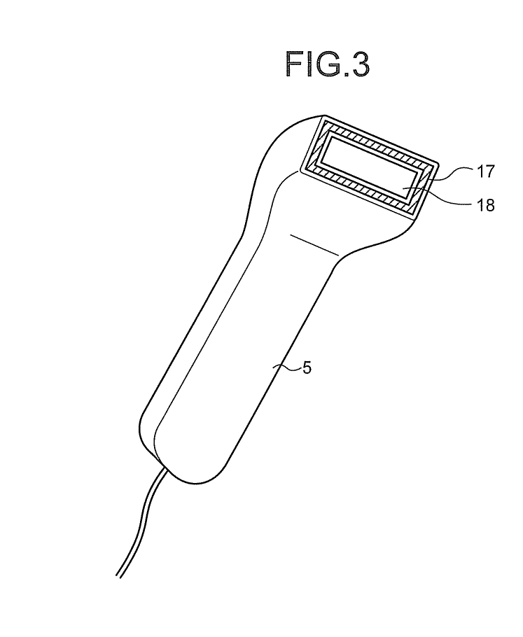

FIG. 3 is a schematic diagram for explaining the configuration of the hand scanner 5. As shown in FIG. 3, a scanner 18 for optically reading a code symbol attached to a commodity is provided at a tip of the hand scanner 5. The antenna 17 for transmitting data for invalidating an RFID tag is provided around the scanner 18. This enables the POS terminal 1 to invalidate an RFID tag for a large commodity.

A functional configuration of the POS terminal 1 is explained below.

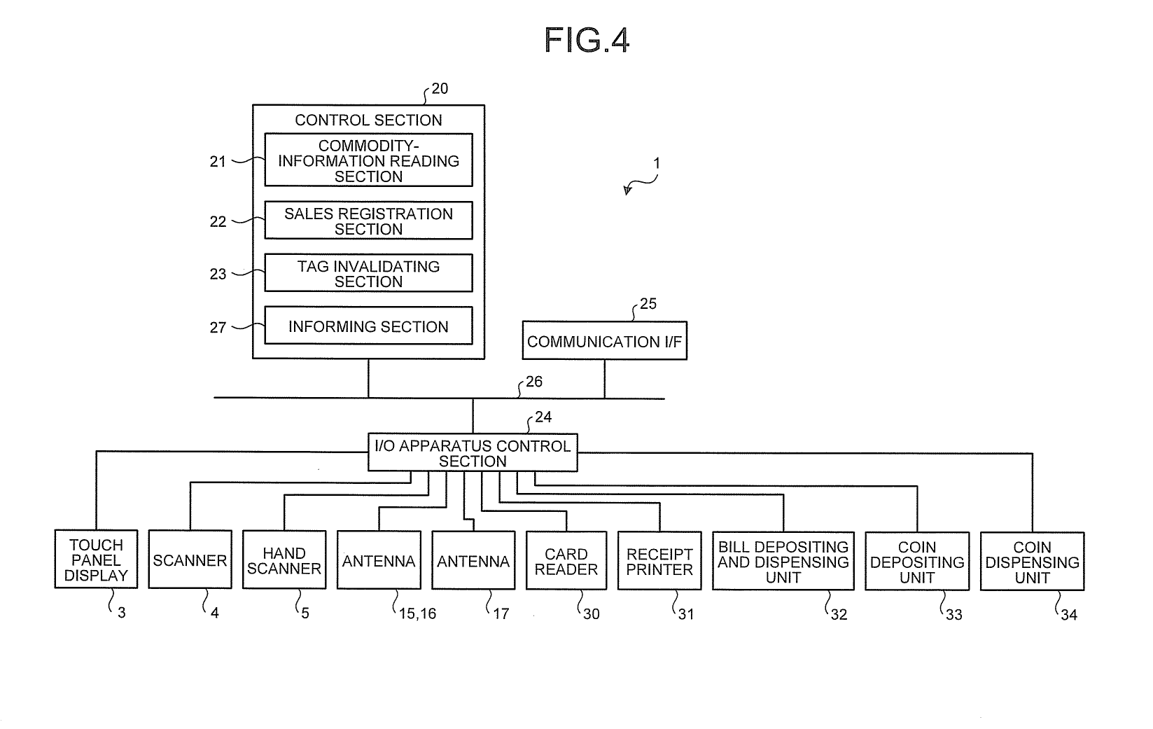

FIG. 4 is a block diagram of the functional configuration of the POS terminal 1. The POS terminal 1 includes a control section 20 having a computer configuration including a central processing unit (CPU), a read only memory (ROM), and a random access memory (RAM) (all of which are not shown in the figure). The ROM has stored therein various computer programs executed by the CPU and various data. The RAM temporarily stores data and a computer program when the CPU executes the various computer programs. The RAM stores sales data indicating a sales record of commodities and various screen display data displayed on the touch panel display 3.

The control section 20 controls, via an input and output (I/O) apparatus control section 24 and a bus 26, I/O apparatuses such as the touch panel display 3, the scanner 4, the hand scanner 5, the antennas 15, 16, and 17, a card reader 30, a receipt printer 31, a bill depositing and dispensing unit 32, a coin depositing unit 33 and a coin dispensing unit 34 and controls an entire system of the POS terminal 1.

The card reader 30 reads information of a point card or a credit card of a customer inserted from the card insertion port 10. The receipt printer 31 prints a receipt after checkout processing and issues the receipt from the receipt issue port 11. The bill depositing and dispensing unit 32 processes bills deposited and dispensed from the bill depositing and dispensing port 12. The coin depositing unit 33 processes coins deposited from the coin depositing port 13. The coin dispensing unit 34 processes coins dispensed from the coin dispensing port 14.

The control section 20 can mutually communicate with a store server connected by a local area network (LAN) via a communication I/F 25 and an attendant terminal for a store clerk (an attendant) for assisting respective kinds of processing of self-check (both of which are no shown in the figure). The store server generally performs management of commodity sales registration processing and the like performed by one or plural POS terminals 1 set in the store. The attendant terminal displays, on a display device, an error occurred in the POS terminal 1 or indication that a customer requests assistance and notifies the attendant of the error or the assistance request.

As shown in FIG. 4, the control section 20 includes a commodity-information reading section 21, a sales registration section 22, a tag invalidating section 23, and an informing section 27.

The commodity-information reading section 21 receives, from the scanner 4 or the hand scanner 5, a signal obtained by reading a code symbol such as a barcode or a two-dimensional code attached to a commodity and reads commodity information such as a commodity code included in the code symbol. The commodity-information reading section 21 may read commodity information such as a commodity code stored by an RFID tag from at least one of the antennas 15, 16, and 17.

When the commodity-information reading section 21 reads commodity information, the sales registration section 22 performs sales registration for commodities on the basis of the read commodity information.

More specifically, the sales registration section 22 checks, referring to a price lookup (PLU) database stored in the POS terminal 1, the not-shown store server, or the like, whether there is commodity information corresponding to a commodity code included in the commodity information received by the commodity-information reading section 21. If there is corresponding commodity information, the sales registration section 22 performs sales registration for a commodity of the commodity information using a commodity name and a commodity price corresponding to the commodity code.

On the other hand, if commodity information corresponding to the commodity code received by the commodity-information reading section 21 is not present in the PLU database, the sales registration section 22 displays a message such as “a store clerk deals with this commodity” on the touch panel display 3. The store clerk inputs, for example, a personal identification number to a ten key displayed on the touch panel display 3 to log in to the system as an authorized person. The store clerk inputs a commodity price using the ten key to perform sales registration.

When a “checkout” key is selected on the touch panel display 3, the sales registration section 22 calculates a purchase amount of all commodities and displays the purchase amount on the touch panel display 3. When a customer selects cash settlement or card settlement on the touch panel, in response to the selection, the sales registration section 22 performs settlement processing by the selected settlement method.

When the commodity-information reading section 21 receives commodity information with the scanner, the tag invalidating section 23 performs radio data communication with an RFID tag attached to a commodity via the antennas 15 and 16 or the antenna 17 and invalidates the RFID tag.

More specifically, when the customer holds a code symbol over the scanner 4 or 5 in order to scan the code symbol, the RFID tag attached to the commodity is brought close to a communicatable range of the antennas 15 and 16 or the antenna 17. When the commodity-information reading section 21 receives a signal corresponding to the commodity information as a signal obtained by reading the code symbol, the tag invalidating section 23 transmits, with this signal as a trigger, data for invalidating the RFID tag from the antennas 15 and 16 or the antenna 17 to the RFID tag.

As an example of invalidation processing for an RFID tag, for example, a flag indicating whether the RFID tag is valid or invalid is provided in a memory region of the RFID tag. The tag invalidating section 23 transmits data for causing the flag of the RFID tag to store indication that the tag is invalid. When the RFID tag receives the data, the flag is set to “invalid” and the RFID tag is invalidated. When the invalidated RFID tag enters a communicatable range of an RFID reader for shoplifting prevention set in a doorway of the store, the RFID reader reads the flag of the RFID tag. If the flag is set to “invalid”, the RFID reader determines that a commodity is properly carried out after purchase and does not sound an alarm for shoplifting prevention.

As another example of the invalidation processing for an RFID tag, the tag invalidating section 23 may transmit a kill command or the like to the RFID tag and invalidate the RFID tag itself. In this case, power supply necessary for RFID communication to the RFID tag is switched off or data is set not to be transmitted from the RFID tag. Therefore, the RFID reader cannot read the RFID tag and does not sound the alarm for shoplifting prevention.

The tag invalidating section 23 determines whether the RFID tag is invalidated. As an example, the tag invalidating section 23 reads the flag after transmitting data for invalidation to the RFID tag. If the flag is set to “invalid”, the tag invalidating section 23 determines that the RFID tag is invalidated.

When the tag invalidating section 23 determines that the RFID tag is invalidated, the informing section 27 sounds a beep and informs the customer that the RFID tag is invalidated or that the commodity information is normally read by the commodity-information reading section 21.

An informing method performed by the informing section 27 is not limited to the beep sounding. As another example, the informing section 27 may inform the customer of invalidation with sound “the RFID tag is invalidated”. The informing section 27 may inform the customer of invalidation by flashing a lamp or displaying “the RFID tag is invalidated” on the touch panel display 3.

In a general POS terminal in the past, a beep is often sounded when commodity information is read by the scanner 4 or the hand scanner 5. In this case, when the beep is sounded, the customer recognizes that scanning is normally completed and moves a commodity away from the scanner 4 or the hand scanner 5.

Therefore, as explained above, the informing section 27 informs the customer of invalidation of the RFID tag by, for example, sounding the beep after confirming that the RFID tag is invalidated. This makes it possible to prevent the customer from moving the commodity away from the antennas 15 and 16 or the antenna 17 before the RFID tag is invalidated and surely invalidate the RFID tag.

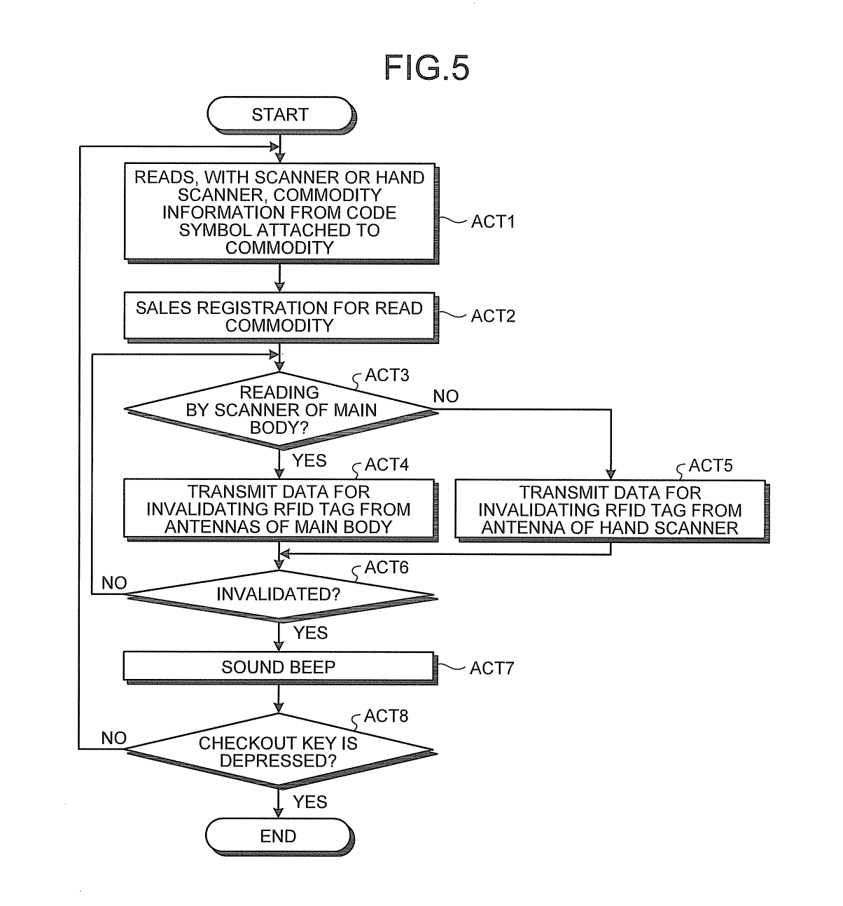

A procedure of tag invalidation processing performed by the POS terminal 1 is explained below. FIG. 5 is a flowchart for explaining the procedure of the tag invalidation processing.

First, when a customer holds a code symbol attached to a commodity over the scanner 4 of the main body 2 or holds the hand scanner 5 over the code symbol attached to the commodity, the commodity-information reading section 21 reads commodity information such as a commodity code included in the code symbol (ACT 1)

As explained above, the commodity-information reading section 21 may reads, with at least one of the antennas 15, 16, and 17, commodity information from an RFID tag attached to the commodity (ACT 1). When both the reading of the code symbol and the reading of the RFID tag are used in this way, if the commodity information is read by data communication of one of the readings, the commodity-information reading section 21 performs sales registration for the commodity using the commodity information read earlier. The commodity-information reading section 21 does not perform the sales registration for a commodity having the same commodity code read by the different methods.

Subsequently, the sales registration section 22 performs, on the basis of the commodity information received in ACT 1, sales registration for the commodity (ACT 2).

When the commodity-information reading section 21 reads the commodity information, the tag invalidating section 23 transmits data for invalidating the RFID tag from the antennas 15 and 16 or the antenna 17. If reading by the scanner 4 of the main body 2 is performed (Yes in ACT 3), the tag invalidating section 23 transmits the data for invalidating the RFID tag from the antennas 15 and 16 of the main body 2 and invalidates the RFID tag (ACT 4).

On the other hand, if the reading by the scanner 4 of the main body 2 is not performed (No in ACT 3), i.e., if reading by the hand scanner 5 is performed, the tag invalidating section 23 transmits the data for invalidating the RFID tag from the antenna 17 of the hand scanner 5 and invalidates the RFID tag (ACT 5).

The tag invalidating section 23 determines whether the RFID tag is invalidated (ACT 6). If the RFID tag is invalidated (Yes in ACT 6), the informing section 27 sounds a beep (ACT 7). If the RFID tag is not invalidated (No in ACT 6), the tag invalidating section 23 returns to ACT 3 and tries invalidation of the RFID tag again (ACTS 3 and 4 or ACTS 3 and 5).

The processing in ACTS 1 to 7 is repeated until sales registration for all commodities is completed and a checkout key of the touch panel display 3 is selected (No in ACT 8).

If the checkout key is selected (Yes in ACT 8), the sales registration section 22 calculates a purchase amount of all the commodities and displays the purchase amount on the touch panel display 3. The sales registration section 22 performs, on the basis of a settlement method selected by the customer on the touch panel, settlement processing by the selected settlement method according to selection of cash settlement or card settlement and ends the processing.

A computer program executed by the POS terminal 1 according to this embodiment has a module configuration including the sections explained above (the commodity-information reading section 21, the sales registration section 22, the tag invalidating section 23, and the informing section 27). As actual hardware, the CPU (a processor) reads out the computer program from the ROM and executes the computer program, whereby the sections are loaded onto a main storage and the commodity-information reading section 21, the sales registration section 22, the tag invalidating section 23, and the informing section 27 are generated on the main storage.

The computer program executed by the POS terminal 1 according to this embodiment is provided while being incorporated in the ROM or the like in advance. The computer program executed by the POS terminal 1 according to this embodiment may be configured to be provided while being recorded in a computer-readable recording medium such as a CD-ROM, a flexible disk (FD), a CD-R, or a digital versatile disk (DVD) as a file of an installable format or an executable format.

Further, the computer program executed by the POS terminal 1 according to this embodiment may be configured to be stored on a computer connected to a network such as the Internet and provided by being downloaded through the network. The computer program executed by the POS terminal 1 according to this embodiment may be configured to be provided or distributed through the network such as the Internet.

As explained above, when the POS terminal 1 according to this embodiment reads a code symbol attached to a commodity with the scanner 4 or the hand scanner 5, the POS terminal 1 invalidates an RFID tag using at least one of the antennas 15, 16, and 17. The antennas 15 and 16 are provided near the reading window of the scanner 4. The antenna 17 is provided near a reading window of the hand scanner 5. Therefore, a customer can invalidate the RFID tag simply by scanning the code symbol attached to the commodity according to a procedure same as the procedure of the sales registration processing in the past. Therefore, there is an effect that the customer can easily invalidate the RFID tag without needing to specifically perform new processing.

The POS terminal 1 according to this embodiment transmits data for invalidating an RFID tag attached to a commodity to the RFID tag from the antenna 16 provided in the place located below the commodity when the commodity is scanned by the scanner 4, in addition to the antenna 15 provided around the scanner 4. Since the antennas 15 and 16 are three-dimensionally arranged with respect to the commodity in this way, there is an effect that it is possible to more surely perform invalidation of the RFID tag.

In the above explanation, the two antennas are provided near the scanner 4. However, the present invention is not limited to this. The POS terminal 1 may include two or more antennas near the scanner 4.

Further effects and modifications can be easily derived by those skilled in the art. Therefore, a wider aspect of the present invention is not limited by the specific details and the representative embodiments represented and described above. Accordingly, various changes are possible without departing from the spirit or the scope of the general concept of the invention defined by the appended claims and their equivalents.

What is claimed is:

1. A sales data processing apparatus comprising:
a commodity-information reading section configured to read, from a scanner, commodity information included in a code symbol attached to a commodity; and
a tag invalidating section configured to invalidate an RFID tag attached to the commodity, when the commodity-information reading section reads the commodity information.

2. The apparatus according to claim 1, further comprising an antenna arranged near the scanner and configured to perform communication with the RFID tag, wherein
the tag invalidating section invalidates the RFID tag via the antenna.

3. The apparatus according to claim 2, wherein a plurality of the antennas are provided and emit radio waves to the RFID tag from different directions.

4. The apparatus according to claim 3, wherein a pair of the antennas are provided,
one antenna is arranged around the scanner, and
the other antenna is arranged in a place located below the commodity when the commodity is held over the scanner.

5. The apparatus according to claim 2, wherein the scanner is a hand scanner that is integrated with the antenna and portable.

6. The apparatus according to claim 1, further comprising an informing section configured to inform that the commodity information is read by the commodity-information reading section, after the tag invalidating section transmits data for invalidating the RFID tag.

7. The apparatus according to claim 1, wherein
the commodity-information reading section determines whether the RFID tag is invalidated, and
the apparatus further comprises an informing section configured to inform that the RFID tag is invalidated, if the commodity-information reading section determines that the RFID tag is invalidated.

8. The apparatus according to claim 2, wherein the tag invalidating section invalidates the RFID tag, by transmitting data which causes a flag provided in the RFID tag to store an indication that the RFID tag is invalid.

9. The apparatus according to claim 2, wherein the commodity-information reading section can read the commodity information using the antenna and reads the commodity information read earlier by one of the scanner and the antenna.

10. The apparatus according to claim 1, wherein the scanner is a scanner of a laser system or a CCD system.

11. A data processing method comprising:
Reading, from a scanner, commodity information included in a code symbol attached to a commodity, by a commodity-information reading section; and
invalidating an RFID tag attached to the commodity, when the commodity-information reading section reads the commodity information, by a tag invalidating section.
